(19) United States
(12) Patent Application Publication
(10) Pub. No.: US 2025/0358607 A1
(43) Pub. Date: Nov. 20, 2025

(54) METHOD AND DEVICE FOR SESSION NEGOTIATION TO USE IMS DATA CHANNEL SERVICE

(71) Applicant: Samsung Electronics Co., Ltd., Suwon-si (KR)

(72) Inventors: Jaehyeon BAE, Suwon-si (KR); Dongyeon KIM, Suwon-si (KR); Jicheol LEE, Suwon-si (KR); Hoyeon LEE, Suwon-si (KR)

(21) Appl. No.: 19/209,198

(22) Filed: May 15, 2025

(30) Foreign Application Priority Data
May 16, 2024 (KR) 10-2024-0063930

(51) Int. Cl. H04W 8/20; H04L 65/1016; H04W 76/20

(52) U.S. Cl. CPC H04W 8/20; H04L 65/1016; H04W 76/20

(57) ABSTRACT

A method performed by a first Internet protocol (IP) multimedia subsystem (IMS) server in a wireless communication system is provided. The method includes receiving a first request message for requesting a temporary connection to an IMS data channel (IMS DC) of a first user equipment (UE), transmitting, to an home subscriber server (HSS) entity, a first subscriber information request message for requesting the first subscriber information of the first UE, receiving, from the HSS entity, a first subscriber information response message comprising the first subscriber information indicating that the first UE is not subscribed to the IMS data channel, determining whether the temporary connection to the IMS data channel of the first UE is allowed, and in response to determining to allow the temporary connection, transmitting a second request message for requesting the temporary connection to the IMS data channel of the first UE to a second IMS server.

### CROSS-REFERENCE TO RELATED APPLICATION(S)

This application is based on and claims priority under 35 U.S.C. 119(a) of Korean patent application number 10-2024-0063930, filed on May 16, 2024, in the Korean Intellectual Property Office, the disclosure of which is incorporated by reference herein in its entirety.

### BACKGROUND

### 1. Field

The disclosure relates to a method and a device for negotiating a data channel session to use an Internet protocol (IP) multimedia subsystem (IMS) data channel service in a wireless communication system. More particularly, the disclosure relates a method and a device for negotiating a data channel session to use an IMS-data channel (DC) service when a terminal supporting the IMS-DC service has no data channel service subscription information for using a data channel service.

### 2. Description of Related Art

5^{th} generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as mm Wave including 28 GHz and 39 GHz. In addition, it has been considered to implement 6th generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an information management method and device by which an originating terminal having no IMS data channel service subscription information supports IMS data channel session establishment, based on subscription information of a counterpart terminal.

Another aspect of the disclosure is to provide a method of processing a control signal in a wireless communication system, the method includes receiving a first control signal transmitted from a base station (BS), processing the received first control signal, and transmitting a second control signal generated based on the processing, to the base station.

Another aspect of the disclosure is to provide a method and a device according to an embodiment. When an originating terminal has no IMS data channel service subscription information, the originating terminal provides IMS data channel session establishment and a data channel service, based on subscription information of a counterpart terminating terminal.

Additional aspects will be set forth in part in the description which follows and, in part, will be apparent from the description, or may be learned by practice of the presented embodiments.

In accordance with an aspect of the disclosure, a method performed by a first Internet protocol (IP) multimedia subsystem (IMS) server in a wireless communication system is provided. The method includes receiving a first request message for requesting a temporary connection to an IMS data channel (IMS DC) of a first user equipment (UE), which is originating UE, transmitting, to an home subscriber server (HSS) entity, a first subscriber information request message for requesting the first subscriber information of the first UE based on the first request message, receiving, from the HSS entity, a first subscriber information response message comprising the first subscriber information indicating that the first UE is not subscribed to the IMS data channel, determining, based on the first subscriber information, whether the temporary connection to the IMS data channel of the first UE is allowed, and in response to determining to allow the temporary connection, transmitting a second request message for requesting the temporary connection to the IMS data channel of the first UE to a second IMS server related to a second UE which is terminating UE.

In accordance with another aspect of the disclosure, a method performed by a second Internet protocol (IP) multimedia subsystem (IMS) server in a wireless communication system is provided. The method includes receiving, from a first IMS server related to a first user equipment (UE) which is an originating UE, a first request message for requesting a temporary connection to an IMS data channel (IMS DC) of the first UE, transmitting, to an Home Subscriber Server (HSS) entity, a second subscriber information request message for requesting second subscriber information of a second UE, which is a terminating UE, based on the first request message, receiving, from the HSS entity, a second subscriber information response message comprising the second subscriber information indicating that the second UE is subscribed to the IMS data channel, determining, based on the second subscriber information, whether the second UE supports the temporary connection to the IMS data channel, and in response to determining that the second UE supports the temporary connection, transmitting, to the second UE, a second request message for requesting the temporary connection to the IMS data channel of the first UE.

In accordance with another aspect of the disclosure, a first Internet protocol (IP) multimedia subsystem (IMS) server in a wireless communication system is provided. The first IME server includes a transceiver, and a controller coupled with the transceiver and configured to receive a first request message for requesting a temporary connection to an IMS data channel (IMS DC) of a first user equipment (UE), which is originating UE, transmit, to an home subscriber server (HSS) entity, a first subscriber information request message for requesting the first subscriber information of the first UE based on the first request message, receive, from the HSS entity, a first subscriber information response message comprising the first subscriber information indicating that the first UE is not subscribed to the IMS data channel, determine, based on the first subscriber information, whether the temporary connection to the IMS data channel of the first UE is allowed, and in response to the determination to allow the temporary connection, transmit a second request message for requesting the temporary connection to the IMS data channel of the first UE to a second IMS server related to a second UE which is terminating UE.

In accordance with another aspect of the disclosure, a second Internet protocol (IP) multimedia subsystem (IMS) server in a wireless communication system is provided. The second IMS server includes a transceiver, and a controller coupled with the transceiver and configured to receive, from a first IMS server related to a first user equipment (UE), which is an originating UE, a first request message for requesting a temporary connection to an IMS data channel (IMS DC) of the first UE, transmit, to an home subscriber server (HSS) entity, a second subscriber information request message for requesting second subscriber information of a second UE, which is a terminating UE, based on the first request message, receive, from the HSS entity, a second subscriber information response message comprising the second subscriber information indicating that the second UE is subscribed to the IMS data channel, determine, based on the second subscriber information, whether the second UE supports the temporary connection to the IMS data channel, and in response to determining that the second UE supports the temporary connection, transmit, to the second UE, a second request message for requesting the temporary connection to the IMS data channel of the first UE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a network structure and interfaces of a 5G system according to an embodiment of the disclosure;

FIG. 2 illustrates an Internet protocol (IP) multimedia subsystem (IMS) data channel (IMS-DC) structure that provides a data channel service based on an IMS service according to an embodiment of the disclosure;

FIG. 3 illustrates a terminal and network operation structure according to a request for a data channel service supporting a conditional data channel session according to an embodiment of the disclosure;

FIG. 4 illustrates a terminal and network operation structure according to a request for a data channel service supporting a conditional data channel session according to an embodiment of the disclosure;

FIG. 5 illustrates a structure of a UE according to an embodiment of the disclosure;

FIG. 6 illustrates a structure of a base station according to an embodiment of the disclosure; and

FIG. 7 illustrates a structure of a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the disclosure, descriptions related to technical contents well-known in the art and not associated directly with the disclosure will be omitted. Such an omission of unnecessary descriptions is intended to prevent obscuring of the main idea of the disclosure and more clearly transfer the main idea. The terms which will be described below are terms defined based on the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. In addition, the size of each element does not completely reflect the actual size. In the respective drawings, the same or corresponding elements are assigned the same reference numerals.

In the following description, a base station is an entity that allocates resources to terminals, and may be at least one of a gNode B, an eNode B, a Node B (or xNode B (where, x is an alphabet including g or e)), a wireless access unit, a base station controller, a satellite, an airborne, and a node on a network. A user equipment (UE) may include a mobile station (MS), a vehicular, a satellite, an airborne, a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Additionally, a “sidelink (SL)” may exist, which refers to a radio link via which a UE transmits a signal to another UE.

Furthermore, in the following description, long-term evolution (LTE) or LTE-Advanced (LTE-A) systems may be described by way of example, but the embodiments of the disclosure may also be applied to other communication systems having similar technical backgrounds or channel types. For example, 5G-Advance, NR-advance, or 6th generation (6G) mobile communication technologies developed beyond 5G mobile communication technologies (or new radio (NR)) may be included therein, and in the following description, the “5G” may be the concept that covers the exiting LTE, LTE-A, or other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

The 3^{rd} generation partnership project (3GPP), which manages a cellular mobile communication standard, has introduced a new core network structure named 5G core (5GC) and has been standardizing same in order to push evolution from a fourth generation (4G) LTE system to a 5G system. 5GC supports the following distinguishable functions, compared to an evolved packet core (EPC) that is a network core for 4G.

In 5GC, a network slicing function is introduced. As requirements of 5G, 5GC is required to support various terminal types and services (e.g., enhanced mobile broadband (eMBB), ultra reliable low latency communications (URLLC), and massive machine type communications (mMTC)). Such terminals/services have different requirements for a core network. For example, the eMBB service may require a high data rate, and the URLLC service may require high stability and low latency. A network slicing technology has been proposed to satisfy these various service requirements.

Network slicing may mean a method of virtualizing one physical network to make many logical networks (e.g., network slices). Activated network slices may be called network slice instances, and each network slice instance (NSI) may have a different characteristic. A mobile communication service provider may configure a network function (NF) suitable for the characteristic of each NSI so as to satisfy various service requirements according to terminals/services. For example, the mobile communication service provider may assign an NSI suitable for the characteristic of a service required thereby, so that many 5G services (e.g., eMBB, URLLC, or mMTC) are efficiently supportable.

5GC may easily support a network virtualization paradigm by separating a mobility management function and a session management function. In 4G LTE, all terminals have been provided with services from a network through signaling exchange with single core equipment, which is called a mobility management entity (MME) serving as registration, authentication, and a mobility management and session management function. In 5G, the number of terminals (e.g., MTC terminals) has grown explosively, and mobility and traffic/session characteristics required to be supported are subdivided according to the types of terminals. Accordingly, if a single entity (e.g., MME) supports all functions, decrease in scalability indicating the addition of an entity for each required function is inevitable. Therefore, in order to improve scalability in terms of signaling loads and the function/implementation complexity of a core entity responsible for a control plane, various functions are being developed based on a structure of separating a mobility management function and a session management function.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

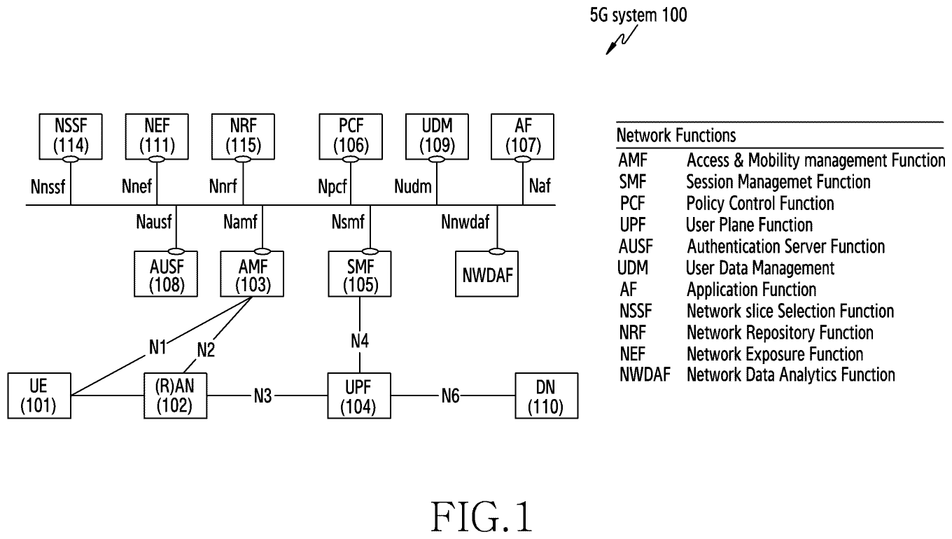

FIG. 1 is a diagram illustrating a network structure and interfaces of a 5G system according to an embodiment of the disclosure.

A network entity included in the network structure of the 5G system of FIG. 1 may include a network function (NF) according to system implementation.

Referring to FIG. 1, the network structure of the 5G system may include various network entities. For example, a 5G system 100 may include an authentication server function (AUSF) entity 108, a (core) access and mobility management function (AMF) entity 103, a session management function (SMF) entity 105, a policy control function (PCF) entity 106, an application function (AF) entity 107, a unified data management (UDM) entity 109, a data network (DN) 110, a network exposure function (NEF) entity 111, a network slicing selection function (NSSF) entity 114, a network repository function (NRF) entity 115, a network data analytics function (NWDAF), an edge application service domain repository (EDR), an edge application server (EAS), an EAS discovery function (EASDF), a user plane function (UPF) entity 104, a (radio) access network ((R)AN) 102, and a terminal, e.g., a user equipment (UE) 101.

Each NF entity of the 5G system 100 may support the following functions.

The AUSF 108 processes and stores data for authentication of the UE 101.

The AMF 103 may provide a function for access and mobility management in a unit of UE, and one UE may be basically connected to one AMF. Specifically, the AMF 103 supports functions, such as inter-CN node signaling for mobility between 3GPP access networks, termination of a radio access network (RAN) CP interface (i.e., N2 interface), termination (N1) of non-access stratum (NAS) signaling, NAS signaling security (NAS ciphering and integrity protection), AS security control, registration management (registration area management), connection management, idle mode UE reachability (including control and execution of paging retransmission), mobility management control (subscription and policies), support of intra-system mobility and inter-system mobility, support of network slicing, SMF selection, lawful interception (for an AMF event and an interface for an LI system), provision of transport of session management (SM) messages between the UE and the SMF, a transparent proxy for routing SM messages, access authentication, access authorization including a roaming right check, provision of transport of SMS messages between the UE and the SMSF, a security anchor function (SAF), and/or a security context management (SCM). Some or all functions of the AMF 103 may be supported in a single instance of one AMF entity.

The DN 110 means, for example, an operator service, an Internet access or 3^{rd} party service, or the like. The DN 110 transmits a downlink protocol data unit (PDU) to the UPF entity 104, or receives a PDU transmitted from the UE 101 from the UPF entity 104.

The PCF entity 106 may provide a function of receiving information on a packet flow from an application server and determining a policy, such as mobility management, session management, or the like. Specifically, the PCF entity 106 supports a function, such as support of a unified policy framework for controlling network operation, provision of a policy rule to enable control plane entity function entity (entities) (e.g., the AMF entity, the SMF entity, or the like) to execute the policy rule, and implementation of a front end for accessing relevant subscription information for policy determination in a user data repository (UDR).

The SMF entity 105 may provide a session management function, and when the UE 101 has multiple sessions, the sessions may be managed by different SMF entities. Specifically, the SMF entity 105 supports a function, such as session management (e.g., session establishment, modification, and release, including tunnel maintenance between the nodes of the UPF entity 140 and the (R)AN 102), UE IP address allocation and management (including selective authentication), selection and control of a UP function, configuration of traffic steering at the UPF entity 104 to route traffic to a proper destination, termination of interfaces towards policy control functions, execution of a control part of a policy and a quality of service (QOS), lawful interception (regarding an SM event and an interface to an LI system), termination of session management (SM) parts of NAS messages, downlink data notification, an initiator of access network (AN)-specific SM information (this is transferred to the (R)AN 102 through N2 via the AMF 103), determination of a session and service continuity (SSC) mode of a session, and a roaming function. Some or all functions of the SMF entity 105 may be supported in a single instance of one SMF entity.

The UDM entity 109 stores a user's subscription data, policy data, or the like. The UDM entity 109 includes two parts, that is, an application front end (FE) and a user data repository (UDR).

The front end (FE) includes a UDM FE in charge of location management, subscription management, and credential processing, and the PCF entity in charge of policy control. The UDR stores data required for functions provided by the UDM-FE, and a policy profile required by the PCF entity. The data stored in the UDR includes an subscription identifier, a security credential, user subscription data including access and mobility-related subscription data and session-related subscription data, and policy data. The UDM-FE accesses subscription information stored in the UDR, and supports a function, such as authentication credential processing, user identification handling), access authentication, registration/mobility management, subscription management, and SMS management.

The UPF entity 104 transfers a downlink PDU received from the DN 110 to the UE 101 via the (R)AN 102, and transfers, to the DN 110, an uplink PDU received from the UE 101 via the (R)AN 102. Specifically, the UPF entity 104 supports a function, such as an anchor point for intra/inter-RAT mobility, an external PDU session point of interconnection to a data network, packet routing and forwarding, packet inspection and a user plane part of policy rule enforcement, lawful interception, traffic usage reporting, an uplink classifier for supporting to route traffic flows to a data network, a branching point for supporting a multi-homed PDU session, QoS handling for a user plane (e.g., packet filtering, gating, and uplink/downlink rate enforcement), uplink traffic verification (service data flow (SDF) mapping between an SDF and a QoS flow), transport level packet marking in uplink and downlink, and a downlink packet buffering and downlink data notification triggering function. Some or all functions of the UPF entity 104 may be supported in a single instance of one UPF.

The AF entity 107 interacts with a 3GPP core network for service provision (e.g., support of a function, such as application influence on traffic routing, access to network capability exposure, and interaction with a policy framework for policy control).

The (R)AN 102 is a generic term for a new radio access network supporting both an evolved E-UTRA that is an evolved version of a 4G radio access technology, and a new radio access technology (new radio, NR) (e.g., gNB).

The gNB supports a function, such as functions for radio resource management (i.e., radio bearer control, radio admission control, connection mobility control, and dynamic allocation of resources to the UE in uplink/downlink (i.e., scheduling)), Internet protocol (IP) header compression, encryption and integrity protection of a user data stream, selection of the AMF at the time of UE attachment in a case where no routing towards the AMF is determined through information provided by the UE, routing of user plane data to the UPF(s), routing of control plane information to the AMF, connection setup and release, scheduling and transmission of paging messages (initiated from the AMF), scheduling and transmission of system broadcast information (initiated from the AMF or operating and maintenance (O&M)), measurement and measurement reporting configuration for mobility and scheduling, transport level packet marking in uplink, session management, support of network slicing, QoS flow management and mapping to a data radio bearer, support of the UE in an inactive mode, a NAS message distribution function, an NAS node selection function, sharing of a radio access network, dual connectivity, and tight interworking between NR and E-UTRA.

The UE 101 refers to a user device. The user equipment may be mentioned using a term, such as a terminal, mobile equipment (ME), and a mobile station (MS). In addition, a user equipment may be a portable device, such as a notebook, a mobile phone, a personal digital assistant (PDA), a smartphone, or a multimedia device, or an unportable device, such as a personal computer (PC) or a vehicle-mounted device.

The NEF 111 provides a means for securely exposing services and capabilities provided by 3GPP network functions, for, for example, a 3^{rd} party, internal exposure/re-exposure, application functions, and edge computing. The NEF 111 receives information (based on exposed capability(s) of other NF(s)) from the other NF(s). The NEF 111 may store received information as structured data by using a standardized interface as a data storage network function. The stored information may be re-exposed to other NF entity (entities) and AF entity (entities) by the NEF entity 111, and may be used for other purposes, such as analysis.

The EASDF (not illustrated) is an NF that is capable of adding, for each fully qualified domain name (FQDN), an address of a domain name system (DNS) server to which a DNS request of the UE is to be forwarded, and an extension mechanisms for DNS (EDNS) client subnet (ECS) option representable by an IP subnet address required to be added when the DNS request of the UE is forwarded. The EASDF receives exchange active sync (EAS) domain configuration information from the EDR, and processes a DNS request message received from the UE, according to the received information. In addition, the EASDF is an NF that performs a function of receiving, from the SMF 105, a UE IP address, location information of the UE in 3GPP, a DNS message handling rule, and a DNS message reporting rule, handling a DNS query message received from the UE and a DNS response message received from a DNS server, and transmitting, according to the DNS message reporting rule, information in a DNS message and statistical information obtained by processing same to the SMF 105.

The NRF 115 supports a service discovery function. The NRF receives an NF discovery request from an NF instance, and provides information of discovered NF instances to the NF instance. In addition, the NRF maintains available NF instances and services supported thereby.

A reference model for a case where the UE 101 accesses the one DN 110 by using one PDU session is illustrated in FIG. 1 as an example for convenience of explanation, but the disclosure is not limited thereto.

The UE 101 may concurrently access two (i.e., local and central) data networks by using multiple PDU sessions. Two SMFs may be selected for different PDU sessions. Each SMF may be capable of controlling both a local UPF and a central UPF in a PDU session.

In addition, the UE 101 may concurrently access two (i.e., local and central) data networks provided in a single PDU session.

In 3GPP systems, conceptual links connecting NFs in the 5G system are defined as reference points. As an example, reference points included in the 5G system 100 of FIG. 1 are as follows.
N1: a reference point between a UE 101 and an AMF 103
N2: a reference point between an (R)AN 102 and an AMF 103
N3: a reference point between an (R)AN 102 and a UPF 104
N4: a reference point between an SMF 105 and a UPF 104
N5: a reference point between a PCF 106 and an AF 107
N6: a reference point between a UPF 104 and a DN 110
N7: a reference point between an SMF 105 and a PCF 106
N8: a reference point between a UDM 109 and an AMF 103
N10: a reference point between a UDM 109 and an SMF 105
N11: a reference point between an AMF 103 and an SMF 105
N12: a reference point between an AMF 103 and an AUSF 108
N13: a reference point between a UDM 109 and an AUSF 108
N14: a reference point between two AMFs 103
N15: a reference point between a PCF and an AMF for a non-roaming scenario, and a reference point between a PCF and an AMF in a visited network for a roaming scenario
Nx: a reference point between an SMF 105 and an EASDF
Ny: a reference point between an NEF (EDF) 111 and an EASDF

An Internet protocol (IP) multimedia subsystem (IMS) system is a system for transmitting IP-based multimedia, and various services, such as voice over LTE (VOLTE) and voice over NR (VoNR) are provided through an existing IMS network linked to an LTE or 5G network. An IMS data channel service aims to provide various supplementary services, such as user location information transmission and screen sharing, using a separate application in addition to an existing voice- or video-based service, by using a data channel service associated with IMS on a voice of the related art, video, or text service based on a real-time transport protocol (RTP). The data channel service associated with IMS may be an Internet protocol (IP) multimedia subsystem-data channel (IMS-DC) service.

To use supplementary services or standalone IMS data channel services using data channels within an IMS data network, a UE may transmit, to a network, a signaling message including a request for a data channel application and relevant configuration information for a data channel-based service through a bootstrap data channel setup signaling procedure. An IMS data channel network having received the signaling message may transfer application or application list information to the UE, based on a configuration of a user or a service provider and request information received from the UE, thereby enabling the UE to download an application for a data channel service.

Based on the application or application list information received from the network, the UE may select an appropriate data channel application according to the performance of the UE and the user's selection, and request the selected data channel application from the network. Additionally, during a bootstrap data channel setup process, the network may allocate a separate media function entity in the network to support downloading of the particular application requested by the UE. The media function entity may receive data channel application-related information (replacement hyper text transfer protocol (HTTP) uniform resource locator (URL) representing the application list offered via the MDC1 interface) convertible to data channel application information, through a media resource management service operation during the bootstrap data channel setup process.

Thereafter, the media function entity may receive, through an Mb interface, information on the particular data channel application selected and requested by the UE, and then convert received data channel application download request information into HTTP URL information recognizable by the IMS data channel network (e.g., DCSF), to support an operation of supporting application downloading of the UE.

The UE may receive each data channel application through a bootstrap connection process, and may receive pieces of information related to the data channel application simultaneously with the reception of the data channel application. Subsequently, the UE may perform an application data channel setup signaling operation to request establishment of a data channel of the received data channel application. An application data channel setup signaling message may include application binding information including configuration information for supporting a particular application and transfer the application binding information to the network together. The network may perform, based on the information (binding information) received from the UE, an operation for at least one application data channel establishment among three types of application data channel establishment including a connection between UEs (peer-to-peer (P2P) application data channel setup), a connection between a UE and an application server (peer-to-application (P2A) application data channel setup), and a connection between UEs through an application server (peer-to-application-to-peer (P2A2P) application data channel setup).

At the time of the IMS-DC service connection, a bootstrap or application data channel establishment operation for connection of a standalone IMS data channel service rather than an IMS data channel service in the form of a supplementary service based on an existing IMS session (e.g., audio/video/messaging) may be requested and performed. In addition, in a case of using a standalone IMS data channel service, when a bootstrap data channel session is established first and the IMS data channel service is used, the bootstrap data channel session may not always be open. For example, the UE may transmit a request for establishment of an application data channel to the network by using a data channel application (e.g., a native application) pre-configured by service providers. The UE may not perform a process of downloading a data channel application and relevant configuration information through establishment of a separate bootstrap data channel session. In addition, if the UE is a UE supporting an IMS-DC service, but the UE does not have data channel service subscription information for using the data channel service, the UE may perform a data channel session negotiation procedure for using the IMS data channel service.

The disclosure describes a method for, when a UE is a UE supporting an Internet protocol (IP) multimedia subsystem (IMS) data channel (DC) service, but the UE does not have data channel service subscription information for using the data channel service, performing a data channel session negotiation procedure for using the IMS data channel service by the UE.

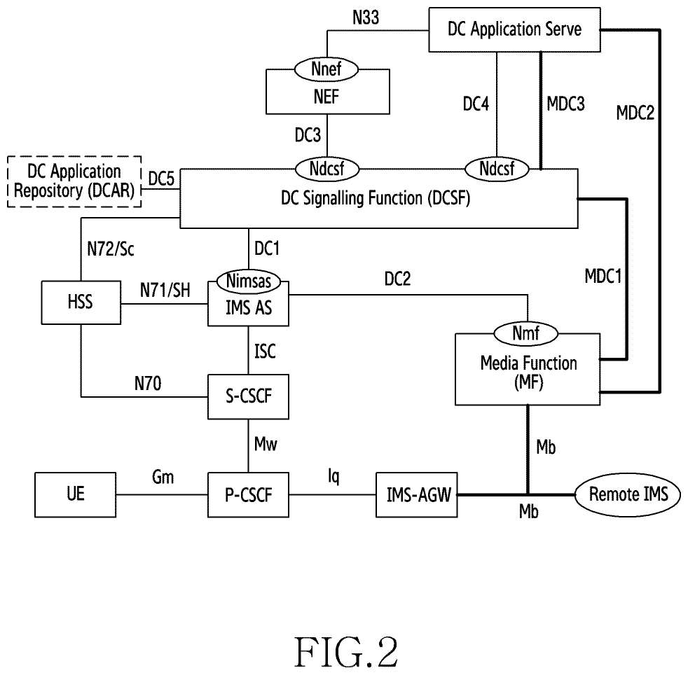

FIG. 2 illustrates an Internet protocol (IP) multimedia subsystem (IMS) data channel (IMS-DC) structure that provides a data channel service based on an IMS service according to an embodiment of the disclosure.

Referring to FIG. 2, a UE may transmit a session initiation protocol (SIP) INVITE message to an existing call session control function (CSCF) for a call session establishment request, such as a proxy-call session control function (P-CSCF) and a serving-call session control function (S-SCSF). The SIP INVITE message may include session description protocol (SDP) information, and a media-related parameter and multiplexing-related requirement information may be included in the SDP information and transmitted to a network. In addition, the UE may include, in the SIP INVITE message, and transfer an SDP offer including bootstrap information together with an SDP offer for establishing an existing video or audio session, in order to use an IMS data channel service.

The serving-call session control function (S-CSCF) having received the SIP INVITE including the pieces of SDP information that may include a media-related parameter and multiplexing-related requirement information may, if the SIP INVITE includes a bootstrap data channel SDP offer for requesting a data channel service connection, transfer the contents of the bootstrap-related SDP offer to an IMS application server (AS). At this time, the S-CSCF may check whether the UE or the network supports IMS-DC, based on the content of the received bootstrap-related SDP offer, and if both the UE and the network support data channels, the S-CSCF may determine to transfer, to the IMS AS, information for establishing a bootstrap data channel for data channel establishment. The IMS AS having received a bootstrap-related SDP offer message from the S-CSCF may first identify whether the UE or a subscriber is able to use a corresponding data channel service, from a home subscriber server (HSS). If the IMS AS identifies, based on a user profile of a corresponding user, that the user is unable to use a data channel, the IMS AS may perform a multimedia telephony (MMTel) session setup operation without data channel establishment through a general IMS process. In addition, if the user is unable to use a data channel-based service, the IMS AS may remove data channel (DC)-related media information from the SIP INVITE message received from the S-CSCF to update the SIP INVITE message, and then transfer the updated SIP INVITE message to the S-CSCF.

In addition, if the service user is able to use an IMS data channel-based service, the IMS AS may perform data channel bootstrapping through a data channel call request to a data channel signaling function (DCSF). The IMS AS may select a DCSF by performing discovery and selection of a DCSF instance by means of an NRF, based on a local configuration of a network service provider or information transferred from UE. For example, the IMS AS may transfer a DCSF-related profile to the NRF and may receive, from the NRF, information on a DCSF discovered and selected by the NRF. The IMS AS may transfer, to the DCSF selected through the above process, a session event control notification (SessionEventControl_Notify) message including information, such as SessionEstablishmentRequestEvent, Session ID, CallingID, CalledID, SessionCase, Event initiator, MediaInfoList, and DC Stream ID.

The DCSF having received a DC control request from the IMS AS (i.e., having received a session event control notification (SessionEventControl_Notify) message from the IMS AS) may determine a policy regarding how to generate a bootstrap data channel, based on a relevant parameter in a DC control request message. In addition, the DCSF may determine MDC1 media information so that the UE may download an application through a media function (MF) or a multimedia resource function (MRF).

Based on determination information (i.e., the determined MDC1 media information), the DCSF may transfer a MediaControl_MediaInstruction message including information, such as Session ID and MediaInstructionSet to the IMS AS. The DCSF may include, in MediaInstructionSet, and transfer, to the IMS AS, an MDC1 media endpoint address, a DC stream ID, and replacement information of the URL of an application list transferred via an MDC1 interface. Based on a process in which the MediaInstructionSet is transferred to the IMS AS, the DCSF may provide the IMS AS with a policy regarding how to generate a bootstrap data channel using an MF on both originating and terminating sides.

The IMS AS may select an MF through a process of searching for and selecting, by using the NRF, (1) an MF instance supporting a DC media function or a local configuration or (2) an enhanced MRF.

The IMS AS may transfer a list of media termination descriptors, through an Nmf_MRM_Create message, to the MF selected in the above process (the process of searching for and selecting an MF instance or an enhanced MRF by using the NRF). IMS AS may request generation of two different media terminations. Among two pieces of media termination information, one piece of media termination information is local bootstrap media-related information, and the other piece of media termination information may represent remote bootstrap media-related information to be provided to a remote UE. Each of the pieces of media termination information may include resource allocation request information of an Mb interface and the MDC1 interface. The MF may transfer a negotiation result of corresponding data channel media resource information to the IMS AS.

The IMS AS may transfer a response for a MediaInstruction request from the DCSF to the DCSF. The response message may include result information of the above operation and negotiation-related information of MDC1 data channel media resource information.

The DCSF may store MDC1 data channel media resource information in a response message for the MediaInstruction request, which is transferred from the IMS AS, and may transfer, to the IMS AS, a response message related to a data channel establishment notification (SessionEventControl_Notify) request received from the IMS AS.

The IMS AS may transmit, to the S-CSCF, an SIP INVITE message including an updated SDP offer to which media information of the MF or enhanced MRF has been added. The S-CSCF may transfer the received SIP INVITE message including the updated SDP offer to a remote network and UE #2 (hereinafter, UE #2) that is a terminating UE.

UE #2 and a terminating network may include a bootstrap data channel-related SDP response in a 18× response message and transfer same to an originating network. According to the received SDP response message, the MF or enhanced MRF may update data channel media resource information of UE #2. Thereafter, UE #2 and the terminating network may transmit a 200 OK response message indicating that a request has been successfully completed to the originating network.

The IMS AS may transfer to the DCSF, a SessionEventControl Notify message including SessionEstablishmentSuccessEvent, SessionID, and MediaInfoList to notify of event information related to a successful session establishment. Thereafter, the IMS AS may receive a response message for a corresponding successful session establishment event notification from the DCSF, and the IMS AS may transfer a 200 OK message indicating that a bootstrap data channel has been established to UE #1 (hereinafter, UE #1) that is an originating UE. Accordingly, a bootstrap data channel may be established between UE #1 and UE #2, and the originating MF or enhanced MRF. Thereafter, UE #1 and UE #2 may transfer an application request message to the MF or enhanced MRF to request a data channel application. If a multi-DC application is supported, UE #1 and UE #2 may request an application list from the MF or enhanced MRF. The MF or MRF may change a root URL to application-related URL information, based on replacement URL information received from the DCSF. Thereafter, the MF may transfer the application request message received from the UEs (UE #1 and UE #2) to the DCSF. The DCSF may provide an application list or appropriate data applications to UE #1 and UE #2 according to the data channel processing capability and the selection of the UEs. If a terminating MF or MRF is used according to MF locations, the UEs may perform the above process through a terminating DCSF and download an appropriate data channel application.

After an IMS session and a bootstrap data channel are established and a data channel application is downloaded to UE #1 and UE #2, UE #1 may transmit an SIP reINVITE message including an updated session description protocol (SDP) to the IMS AS. The updated SDP may include not only bootstrap data channel information but also application data channel request information and relevant DC application binding information.

The IMS AS may determine, based on user subscription data information, whether to notify the DCSF of a media change request event. If the IMS AS determines to notify the DCSF of the event, the IMS AS may transfer, to the DCSF, an SessionEventControl_Notify message including MediaChangeRequest Event, Session ID, Event Direction, Event initiator, and Media Info List.

After the DCSF receives a session event notification message (SessionEventControl_Notify), the DCSF may determine a policy regarding how to perform an application data channel establishment request, according to the related parameters transferred through the notification message and a policy of the network service provider. A target endpoint of the DCSF is UE #2, and if an anchor of the local MF or enhanced MRF is not required, the DCSF may determine to add an application data channel media descriptor to an SDP offer. If the local MF or enhanced MRF is required as an anchor of an application data channel, the DCSF may transfer a Nimsas_MediaControl message to the IMS AS to indicate the IMS AS to perform data channel media resource allocation for the MF or enhanced MRF.

The DCSF may transfer a response for the session event notification message to the IMS AS. Thereafter, the IMS AS may transfer a SIP reINVITE message to the originating S-CSCF, and the S-CSCF may transfer same to the terminating network and UE #2.

UE #2 and the terminating network may include a 200 OK response in an application data channel-related SDP response and transfer same to the originating network. Thereafter, the IMS AS having received an SDP offer response message including 200 OK from the terminating network may notify the DCSF of information related to a successful data channel change. The DCSF may transmit a response for a notification to the IMS AS, and thereafter, the IMS AS may transfer an 200 OK response to UE #1 via the originating S-CSCF and P-CSCF. At this time, the P-CSCF of the originating network may perform a QoS procedure for application data channel media, based on SDP response information including an 200 OK response. UE #1 may transfer an ACK to the terminating network. Through the above process, an operation of establishing an application data channel between UE #1 and UE #2 may be performed.

In the above description, the terms, such as an 200 OK response and an SDP offer response message are used merely for convenience of explanation and are not intended to limit the scope of the disclosure, and it is obvious that the terms are expressible in various forms by being changed/extended to general terms that perform substantially the same function/operation.

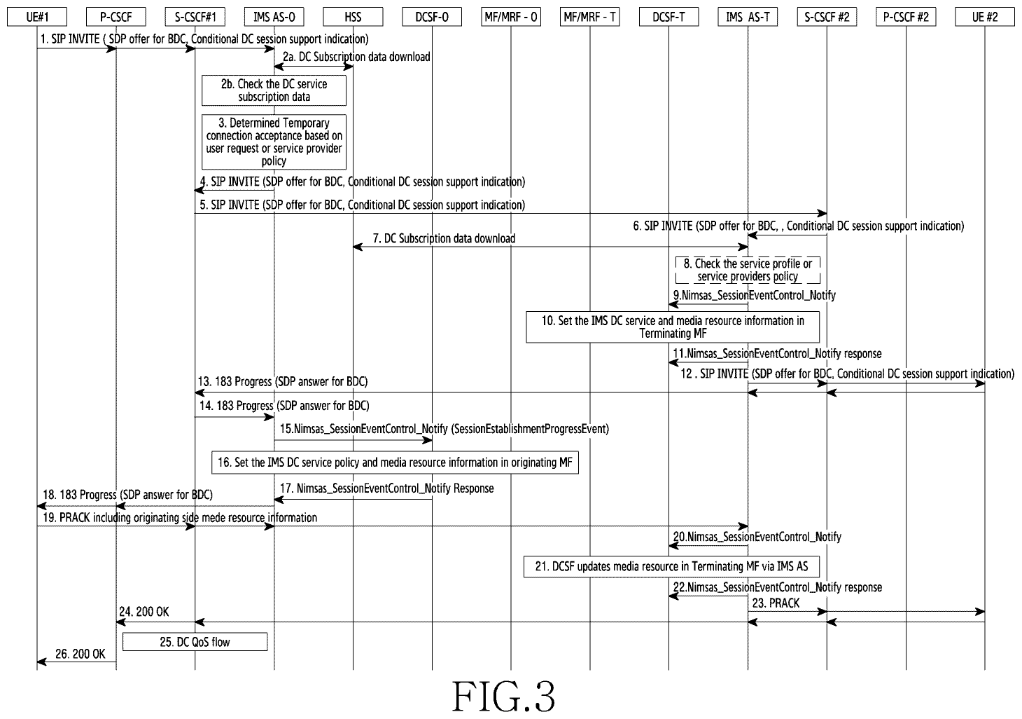

FIG. 3 illustrates a UE and network operation structure according to a request for a data channel service supporting a conditional data channel session according to an embodiment of the disclosure.

Referring to FIG. 3, in an embodiment of the disclosure, even when an originating UE (UE #1) has no IMS data channel service subscription information, the originating UE (UE #1) may use IMS data channel session establishment and a data channel service, based on subscription information of a counterpart UE (UE #2). To this end, conditional requesting and performing of a bootstrap data channel session establishment operation may be allowed at the originating UE (UE #1) or an originating IMS AS.

In stage 1, the originating IMS AS may receive a data channel session establishment message including separate conditional data channel session support request information (e.g., conditional DC session support indication) from the originating UE (UE #1).

In stages 2a, 2b, and 3, after receiving a data channel session establishment request message of the originating UE (UE #1), even if UE #1 is identified as not being subscribed to a data channel service, based on the user (UE #1)-related subscription information downloaded from an HSS, the originating IMS AS may determine conditional data channel session support, based on subscription information of the counterpart UE (UE #2).

In stages 4 and 5, if the originating IMS AS determines conditional data channel session support for a data channel session establishment request of the UE in the stages (stages 1 to 3), the originating IMS AS may generate conditional data channel session support request information (e.g., conditional DC session support indication), include the generated conditional data channel session support request information in a data session establishment request message (SIP (re)INVITE) that is transferred to a terminating network and UE (UE #2), and transfer the message to the terminating network.

In stage 6, a terminating S-CSCF having received a bootstrap data session establishment request message (SIP (re)INVITE) including the conditional data channel session support request information (e.g., conditional DC session support indication) from an originating network may transfer the message to a terminating IMS AS.

In stages 7 and 8, the terminating IMS AS may download the subscription information of the terminating UE (UE #2) from the HSS and may determine, based on the subscription information of the terminating UE (UE #2), whether the terminating UE (UE #2) is a UE capable of using a corresponding data channel service based on conditional data channel session support.

In stages 9 to 11, if the data channel service based on conditional data channel session support is providable, based on a configuration of the terminating network and the subscription information of the UE (or if the IMS AS determines, based on the configuration of the terminating network and the subscription information of the UE, that the data channel service based on conditional data channel session support is providable), the terminating IMS AS may request a terminating data channel server (e.g., a DCSF and an MF) to establish a bootstrap data channel session. The terminating IMS AS may request the terminating DCSF to perform an operation of generating a data channel-related policy and allocating media resources in the terminating DCSF and MF, based on information (SDP offer for bootstrap DC) for establishing a bootstrap data channel session, which is received from the originating network and UE, and may receive a result of the request to the terminating DCSF from the DCSF.

In stage 12, the terminating IMS AS may transfer, to UE #2, a data channel session establishment request message (SIP (re)INVITE) including information on a modified SDP offer for bootstrap DC, which is updated based on media resource allocation information at the terminating side received from the DCSF.

In stages 13 and 14, UE #2 having received the data channel session establishment request message (SIP (re)INVITE) including the information on the modified SDP offer for bootstrap DC may accept a bootstrap data channel session using the subscription information of UE #2, and if the bootstrap data channel session establishment requested by UE #1 is allowed, UE #2 may notify the originating IMS AS through a 183 Progress message that the bootstrap data channel session establishment of UE #1 based on a conditional data channel session has been accepted.

In stages 15 to 17, the originating IMS AS may request a DCSF to perform bootstrap data channel configuration, including generation of a data channel policy of the originating network for establishing a bootstrap data channel session with the terminating MF, based on SDP answer information transferred by the terminating UE (UE #2).

In stage 18, the originating IMS AS having received, from the DCSF, information indicating that configuration, in the terminating MF, for the bootstrap data channel session establishment has been completed may transfer, to UE #1 through a 183 Progress message, the acceptance of the bootstrap data channel session establishment based on the conditional data channel session.

In stage 19, UE #1 may transfer, to UE #2, a PRACK message indicating that the 183 Progress message has been received. The PRACK message may include media resource information at the side of UE #1 for the bootstrap data channel session establishment.

In stages 20 to 22, the terminating IMS AS having received the PRACK message including the media resource information at the side of UE #1 from UE #1, may transfer relevant information to the terminating DCSF to request the DCSF to update the media resource information of at the side of UE #1 (originating) in the terminating MF.

In stage 23, the terminating IMS AS having received, from the terminating DCSF, successful completion of the update of the media resource information at the side of UE #1 (originating) in the terminating MF has been successfully completed may transfer the PRACK message received from UE #1 to UE #2.

In stages 24 to 26, UE #2 may transfer, to UE #1 by using a 200 OK message, successful completion of the bootstrap data channel session establishment using the terminating network. An originating P-CSCF having received the 200 OK message from UE #2 may allocate QoS related to the data channel service and finally transfer, to UE #1 through the 200 OK message, successful completion of the bootstrap data channel session establishment.

In the above description, the terms (PRACH message, 200 OK message, or the like) are used merely for convenience of explanation and are not intended to limit the scope of the disclosure, and it is obvious that the terms are expressible in various forms by being changed/extended to general terms that perform substantially the same function/operation.

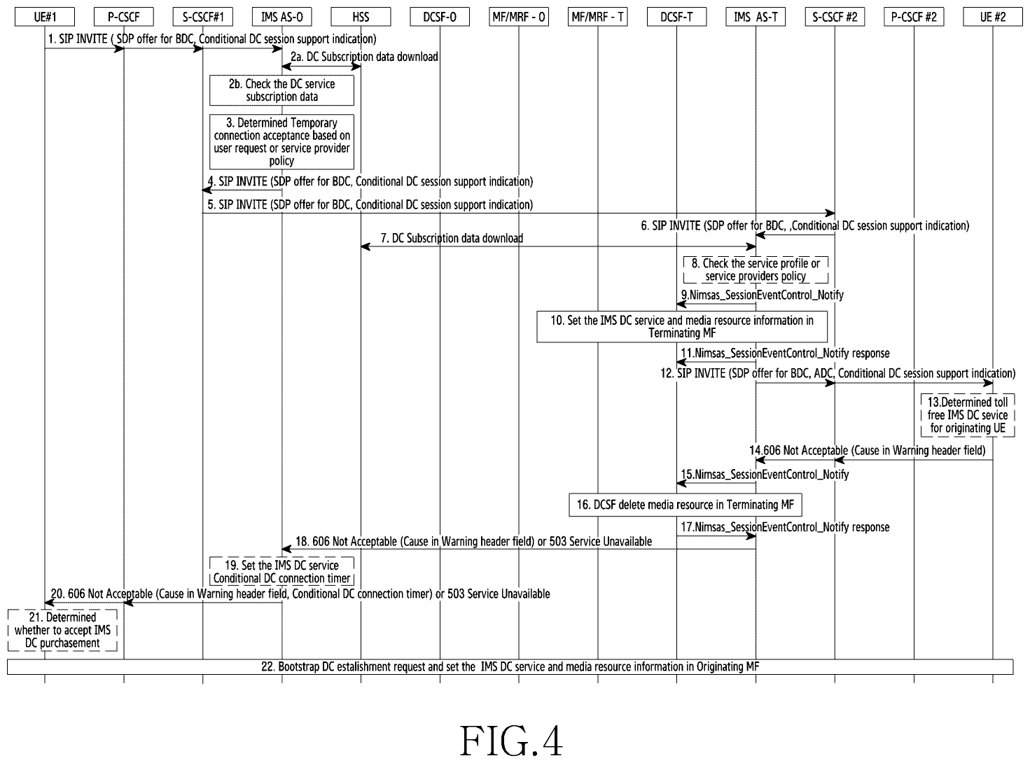

FIG. 4 illustrates a UE and network operation structure according to a request for a data channel service supporting a conditional data channel session according to an embodiment of the disclosure.

Referring to FIG. 4, in an embodiment of the disclosure, even when an originating UE (UE #1) has no IMS data channel service subscription information, the originating UE (UE #1) may use IMS data channel session establishment and a data channel service, based on subscription information of a counterpart UE (UE #2). To this end, conditional requesting and performing of a bootstrap data channel session establishment operation may be allowed at the originating UE (UE #1) or an originating IMS AS.

In stage 1, the originating IMS AS may receive a data channel session establishment message including separate conditional data channel session support request information (e.g., conditional DC session support indication) from the originating UE (UE #1).

In stages 2a, 2b, and 3, after receiving a data channel session establishment request message of the originating UE (UE #1), even if UE #1 is identified as not being subscribed to a data channel service, based on the user (UE #1)-related subscription information downloaded from an HSS, the originating IMS AS may determine conditional data channel session support, based on subscription information of the counterpart UE (UE #2).

In stages 4 and 5, if the originating IMS AS determines conditional data channel session support for a data channel session establishment request of the UE in the stages (stages 1 to 3), the originating IMS AS may generate conditional data channel session support request information (e.g., conditional DC session support indication), include the generated conditional data channel session support request information in a data session establishment request message (SIP (re)INVITE) that is transferred to a terminating network and UE (UE #2), and transfer the message to the terminating network.

In stage 6, a terminating S-CSCF having received a bootstrap data session establishment request message (SIP (re)INVITE) including the conditional data channel session support request information (e.g., conditional DC session support indication) from an originating network may transfer the message to a terminating IMS AS.

In stages 7 and 8, the terminating IMS AS may download the subscription information of the terminating UE (UE #2) from the HSS and may determine, based on the subscription information of the terminating UE (UE #2), whether the terminating UE (UE #2) is a UE capable of using a corresponding data channel service based on conditional data channel session support.

If, in stage 8, the data channel service based on conditional data channel session support is not providable, based on a configuration of the terminating network and the subscription information of the UE (or if the terminating IMS AS determines, based on the configuration of the terminating network and the subscription information of the UE, that the data channel service based on conditional data channel session support is not providable), stage 9 to stage 17 are omissible. Thereafter, the terminating IMS AS may transfer, to the originating network through stage 18, a rejection message (e.g., 503 Service Unavailable message) indicating that the data channel service based on conditional data channel session support is not supported by a server (terminating network). The originating IMS AS having received, from the terminating network, the rejection message (e.g., 503 Service Unavailable message) indicating that the data channel service based on conditional data channel session support is not supported by the server (terminating network) may transfer the rejection message to UE #1 to indicate that the bootstrap data channel session establishment based on conditional data channel session support requested by UE #1 has been rejected.

In stages 9 to 11, if the data channel service based on conditional data channel session support is providable, based on a configuration of the terminating network and the subscription information of the UE (or if the terminating IMS AS determines, based on the configuration of the terminating network and the subscription information of the UE, that the data channel service based on conditional data channel session support is providable), the terminating IMS AS may request a terminating data channel server (e.g., a DCSF and an MF) to establish a bootstrap data channel session. The terminating IMS AS may request the terminating DCSF to perform an operation of generating a data channel-related policy and allocating media resources in the terminating DCSF and MF, based on information (SDP offer for bootstrap DC) for establishing a bootstrap data channel session, which is received from the originating network and UE, and may receive a result of the request to the terminating DCSF from the DCSF.

In stage 12, the terminating IMS AS may transfer, to UE #2, a data channel session establishment request message (SIP (re)INVITE) including information on a modified SDP offer for bootstrap DC, which is updated based on media resource allocation information at the terminating side received from the DCSF.

In stages 13 and 14, if the terminating network (e.g., IMS AS) has determined, based on the data channel session establishment request message from the originating side, that the terminating network (e.g., IMS AS) supports a conditional data channel session, and has determined, based on the subscription information of UE #2, that UE #2 corresponds to a subscriber capable of using a conditional data channel session service, but UE #2 rejects bootstrap data channel session establishment based on a conditional data channel session of the service, UE #2 may transfer a 606 Not Acceptable message including a cause (e.g., reject to conditional session establishment using UE #2 subscription data) to the originating network and UE.

In stages 15 to 17, the terminating IMS AS having received the 606 Not Acceptable message may request the DCSF to perform an operation of updating a bootstrap data channel configuration, such as removal of a data channel policy of the terminating network and media resources in the MF for the bootstrap data channel session establishment based on a conditional data channel session.

In stage 18, the terminating IMS AS, having received, from the DCSF, information indicating that the update of the bootstrap data channel session configuration in the terminating MF has been completed may transfer, to the originating IMS AS, a 606 Not Acceptable message including cause information notifying that the bootstrap data channel session establishment based on a conditional data channel session has been rejected due to the selection of UE #2.

In stage 19, the originating IMS AS having received, from the terminating UE, the 606 Not Acceptable message including the cause information notifying that the bootstrap data channel session establishment based on a conditional data channel session has been rejected may reject the bootstrap data channel session establishment based on a conditional data channel session of UE #1 or may notify UE #1 of the need to subscribe to the data channel service. If the originating IMS AS notifies UE #1 of the need to subscribe to the data channel service, the IMS AS may generate conditional establishment timer (e.g., conditional session timer) information.

If the originating IMS AS notifies UE #1 of the need to subscribe to the data channel service, the IMS AS may transfer, to an originating DCSF, a bootstrap data channel session configuration request including the conditional establishment timer (e.g., conditional session timer) information to an originating DCSF to request a data channel policy and media resource allocation in an MF related to a bootstrap data channel. If UE #1 does not subscribe to the data channel service within a conditional establishment timer (e.g., conditional session timer) (within the time after the conditional establishment timer starts and before same expires), the IMS AS may finally reject the conditionally generated bootstrap data channel session establishment request and may perform an operation of removing relevant data channel media resource information in the originating DCSF and MF. By using the conditional establishment timer (e.g., conditional session timer) information, the IMS AS may finally reject the bootstrap data channel session establishment based on a conditional data channel session requested by UE #1 and may determine termination of the corresponding session.

If, based on the cause information, in the 606 Not Acceptable message, notifying that the bootstrap data channel session establishment based on a conditional data channel session has been rejected, the cause of the rejection corresponds to a case where UE #2 does not support the data channel service or UE #2 rejects the data channel service, such as “UE #2 is not capable to DC” or “UE #2 does not accept DC session,” the 606 Not Acceptable message may be transferred to UE #1 without generating information, such as the conditional establishment timer (e.g., conditional session timer) information.

In stage 20, the originating IMS AS may transfer, to UE #1, a 606 Not Acceptable message including the conditional establishment timer (e.g., conditional session timer) information and the cause information indicating that the bootstrap data channel session establishment based on a conditional data channel session has been rejected.

In stage 21, based on the conditional establishment timer (e.g., conditional session timer) information and the cause information indicating that the bootstrap data channel session establishment based on a conditional data channel session has been rejected, UE #1 may determine to change subscription information to use the data channel service (e.g., determine to subscribe to IMS data service). If there is no data channel subscription request information of UE #1, such as the conditional establishment timer (e.g., conditional session timer), or if the cause information indicating that the bootstrap data channel session establishment based on a conditional data channel session has been rejected indicates that UE #2 has rejected the data channel service or that UE #2 is a UE not supporting the data channel service, stage 21 may be omitted.

If UE #1 has subscribed to the IMS data service in stage 21, in stage 22, UE #1 may transfer a SIP re-INVITE message to the originating IMS AS to perform an operation of allocating media resource information and configuration information for bootstrap data channel session establishment using the originating DCS (e.g., DCSF and MF), and an operation of transferring, to UE #2, a bootstrap data channel session establishment request message for general bootstrap data channel session establishment using the subscription information of each UE. Through the above process, an operation of establishing a bootstrap data channel session between UE #1 and UE #2 may be performed.

In the above description, the terms (PRACH message, 200 OK message, or the like) are used merely for convenience of explanation and are not intended to limit the scope of the disclosure, and it is obvious that the terms are expressible in various forms by being changed/extended to general terms that perform substantially the same function/operation.

According to an embodiment of the disclosure, a method of an originating IMS application server (AS) entity includes receiving a data channel session establishment request message including conditional data channel session support request information (e.g., conditional DC session support indication) and bootstrap data channel-related session description protocol (SDP) offer information, the data channel session establishment request message being transferred from a UE through a serving-call session control function (S-CSCF), after an originating IMS AS receives the data channel session establishment request message of the UE, even in case that UE #1 is identified as not being subscribed to a data channel service, based on user (UE #1)-related subscription information downloaded from an HSS, and determining conditional data channel session support, based on subscription information of a counterpart UE (UE #2), in case that the originating IMS AS determines conditional data channel session support for the data channel session establishment request of the UE, generating conditional data channel session support request information (e.g., conditional DC session support indication), transmitting a data session establishment request message (SIP (re)INVITE) including the conditional data channel session support request information (e.g., conditional DC session support indication) to a terminating network and the terminating UE (UE #2), receiving a 183 Progress message including an SDP answer for BDC and a cause (e.g., reject to conditional session establishment using UE #2 subscription data) from the terminating UE, rejecting bootstrap data channel session establishment based on a conditional data channel session of UE #1 or notifying UE #1 of a need to subscribe to the data channel service, determining to generate conditional establishment timer (e.g., conditional session timer) information, based on the 183 Progress message received from the terminating UE, transferring a bootstrap data channel session configuration request including the conditional establishment timer (e.g., conditional session timer) information to an originating DCSF, and in case that UE #1 does not subscribe to the data channel service within a conditional establishment timer (e.g., conditional session timer), transferring, to UE #1, a message indicating that the IMS AS finally rejects a conditionally generated bootstrap data channel session establishment request.

According to an embodiment of the disclosure, a method of a terminating IMS application server (AS) entity includes receiving a bootstrap data session establishment request message (SIP (re)INVITE) including conditional data channel session support request information (e.g., conditional DC session support indication) from an originating network through a terminating S-CSCF, determining, by a terminating network, whether to perform conditional data channel session support and downloading subscription information of a terminating UE (UE #2) from an HSS to determine whether the terminating UE (UE #2) is a UE capable of using a data channel service based on the conditional data channel session support, in case that the data channel service based on the conditional data channel session support is determined as being providable, based on a configuration of the terminating network and the subscription information of the UE, transferring a message that requests generation of a bootstrap data channel session to a terminating data channel server (e.g., DCSF and MF), transferring, to a terminating DCSF, information that requests generation of a data channel-related policy and allocation of media resources in the terminating DCSF and a terminating MF, based on information (SDP offer for bootstrap DC) for establishing a bootstrap data channel session, the information being received from the originating network and an originating UE, transferring, to UE #2, a data channel session establishment request message (SIP (re)INVITE) including information on a modified SDP offer for bootstrap DC, which is updated based on information on media resource allocation in the DCSF and the MF received from the terminating DCSF, and in case that a terminating IMS AS determines that the terminating network (e.g., IMS AS) is unable to support a conditional data channel session, based on a data channel session establishment request message of an originating side, or determines that UE #2 corresponds to a subscriber incapable of using a conditional data channel session service, based on the subscription information of UE #2, transferring, to the originating side, a response message that rejects the data channel session establishment request message of the originating side.

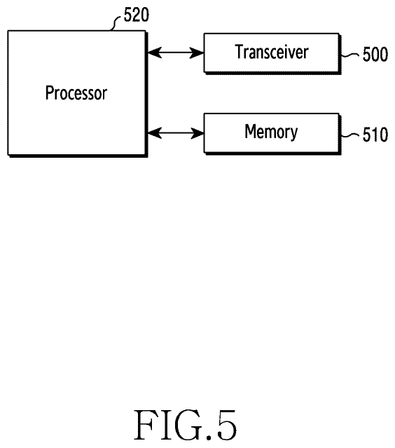

FIG. 5 illustrates a structure of a UE according to an embodiment of the disclosure.

Referring to FIG. 5, the UE according to an embodiment of the disclosure may include a processor 520 which controls the overall operation of the UE, a transceiver 500 which includes a transmitter and a receiver, and memory 510. Of course, the example given above is not limiting, and the UE may include a smaller or larger number of components than the components illustrated in FIG. 5.

According to an embodiment of the disclosure, the transceiver 500 may transmit/receive signals with network entities or other UEs. The signals transmitted/received with network entities may include control information and data. In addition, the transceiver 500 may receive signals through a radio channel, output the same to the processor 520, and transmit signals output from the processor 520 through the radio channel.

According to an embodiment of the disclosure, the processor 520 may control the UE to perform operations according to any one of the above-described embodiments. Of course, the processor 520, the memory 510, and the transceiver 500 are not necessarily implemented as separate modules, but may be implemented as a single component unit, such as a single chip. Furthermore, the processor 520 and the transceiver 500 may be electrically connected to each other. In addition, the processor 520 may include an application processor (AP), a communication processor (CP), a circuit, an application-specific circuit, a controller, or at least one processor.

According to an embodiment of the disclosure, the memory 510 may store data, such as basic programs for operations of the UE, application programs, and configuration information. More particularly, the memory 510 provides the stored data at the request of the processor 520. The memory 510 may include storage media, such as read only memory (ROM), random access memory (RAM), hard disk, compact disc-ROM (CD-ROM), and digital versatile disc (DVD), or a combination of storage media. In addition, the memory 510 may include multiple memories. Furthermore, the processor 520 may perform the above-described embodiments of the disclosure, based on the programs for performing the embodiments, stored in the memory 510.

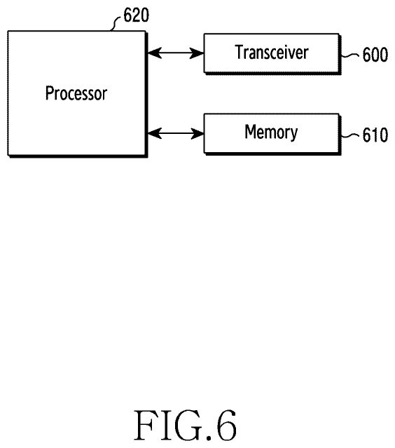

FIG. 6 illustrates a structure of a base station according to an embodiment of the disclosure.

The base station of FIG. 6 may refer to the RAN node or BS described in the embodiments of FIGS. 1 to 4.

Referring to FIG. 6, the base station according to an embodiment of the disclosure may include a processor 620 which controls the overall operation of the base station, a transceiver 600 which includes a transmitter and a receiver, and memory 610. Of course, the example given above is not limiting, and the base station may include a smaller or larger number of components than the components illustrated in FIG. 6.

According to an embodiment of the disclosure, the transceiver 600 may transmit/receive signals with at least one of UEs, other base stations, or network entities. The transmitted/received signals may include at least one of control information and data.

According to an embodiment of the disclosure, the processor 620 may control the base station to perform operations according to any one of the above-described embodiments. The processor 620, the transceiver 600, and the memory 610 are not necessarily implemented as separate modules, but may be implemented as a single component unit, such as a single chip. In addition, the processor 620 may be an application processor (AP), a communication processor (CP), a circuit, an application-specific circuit, or at least one processor. The transceiver 600 may include an interface which wiredly/wirelessly transmits/receive signals to/from UEs, other base stations, or network entities.

The memory 610 may store basic programs, application programs, and data, such as configuration information, for the operation of the corresponding base station. In addition, the memory 610 provides the stored data at the request of the processor 620. The memory 610 may include storage media, such as ROM, RAM, hard disk, CD-ROM, and DVD, or a combination of storage media.

In addition, the memory 610 may include multiple memories. Furthermore, the processor 620 may perform at least one of the above-described embodiments of the disclosure, based on the programs for performing at least one of the embodiments, stored in the memory 610.

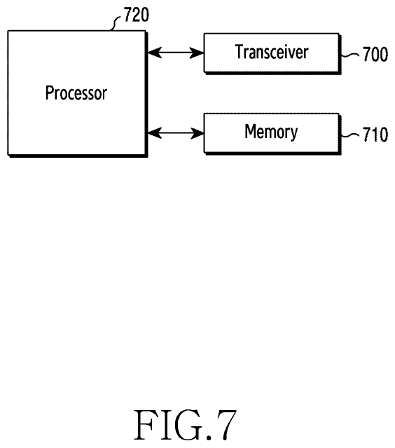

FIG. 7 illustrates a structure of a network entity according to an embodiment of the disclosure.

Referring to FIG. 7, the network entity according to an embodiment of the disclosure may include a processor 720 which controls the overall operation of the network entity, a transceiver 700 which includes a transmitter and a receiver, and memory 710. Of course, the example given above is not limiting, and the network entity may include a smaller or larger number of components than the components illustrated in FIG. 7.

According to an embodiment of the disclosure, the transceiver 700 may transmit/receive signals with at least one of other network entities or UEs. The signals transmitted/received with at least one of other network entities or UEs may include control information and data.

According to an embodiment of the disclosure, the processor 720 may control the network entity to perform operations according to any one of the above-described embodiments. Of course, the processor 720, the memory 710, and the transceiver 700 are not necessarily implemented as separate modules, but may be implemented as a single component unit, such as a single chip. Furthermore, the processor 720 and the transceiver 700 may be electrically connected to each other. In addition, the processor 720 may include an application processor (AP), a communication processor (CP), a circuit, an application-specific circuit, a controller, or at least one processor.

According to an embodiment of the disclosure, the memory 710 may store data, such as basic programs for operations of the network entity, application programs, and configuration information. More particularly, the memory 710 provides the stored data at the request of the processor 720. The memory 710 may include storage media, such as ROM, RAM, hard disk, CD-ROM, and DVD, or a combination of storage media. In addition, the memory 710 may include multiple memories. Furthermore, the processor 720 may perform the above-described embodiments of the disclosure, based on the programs for performing the embodiments, stored in the memory 710.

In the drawings in which methods of the disclosure are described, the order of the description does not always correspond to the order in which operations are performed, and the order relationship between the operations may be changed or the operations may be performed in parallel. Alternatively, in the drawings in which methods of the disclosure are described, some elements may be omitted and only some elements may be included therein without departing from the essential spirit and scope of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks, such as the Internet, Intranet, local area network (LAN), wide LAN (WLAN), and storage area network (SAN) or a combination thereof. Such a storage device may access the electronic device via an external port. In addition, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first Internet protocol (IP) multimedia subsystem (IMS) server in a wireless communication system, the method comprising:
receiving a first request message for requesting a temporary connection to an IMS data channel (IMS DC) of a first user equipment (UE), which is originating UE;
transmitting, to an home subscriber server (HSS) entity, a first subscriber information request message for requesting the first subscriber information of the first UE based on the first request message;
receiving, from the HSS entity, a first subscriber information response message comprising the first subscriber information indicating that the first UE is not subscribed to the IMS data channel;
determining, based on the first subscriber information, whether the temporary connection to the IMS data channel of the first UE is allowed; and
in response to determining to allow the temporary connection, transmitting a second request message for requesting the temporary connection to the IMS data channel of the first UE to a second IMS server related to a second UE which is terminating UE.

2. The method of claim 1, wherein the receiving of the first request message comprises receiving the first request message from the first UE via a first serving call session control function (S-CSCF) related to the first UE.

3. The method of claim 2, wherein the transmitting of the second request message comprises transmitting the second request message to a second S-CSCF related to the second UE via the first S-CSCF.

4. The method of claim 1, wherein the determining of whether the temporary connection to the IMS data channel of the first UE is allowed comprises determining whether to allow the temporary connection to the IMS data channel of the first UE based on a second subscriber information of the second UE subscribed to the IMS data channel.

5. The method of claim 4, further comprising:
receiving, from the second IMS server, a first response message for allowing the temporary connection based on the second subscriber information;
allowing the temporary connection to the IMS data channel of the first UE in response to receiving the first response message; and
transmitting, to the first UE, a second response message representing that the temporary connection of the first UE is allowed.

6. A method performed by a second Internet protocol (IP) multimedia subsystem (IMS) server in a wireless communication system, the method comprising:
receiving, from a first IMS server related to a first user equipment (UE) which is an originating UE, a first request message for requesting a temporary connection to an IMS data channel (IMS DC) of the first UE;
transmitting, to an Home Subscriber Server (HSS) entity, a second subscriber information request message for requesting second subscriber information of a second UE, which is a terminating UE, based on the first request message;
receiving, from the HSS entity, a second subscriber information response message comprising the second subscriber information indicating that the second UE is subscribed to the IMS data channel;
determining, based on the second subscriber information, whether the second UE supports the temporary connection to the IMS data channel; and
in response to determining that the second UE supports the temporary connection, transmitting, to the second UE, a second request message for requesting the temporary connection to the IMS data channel of the first UE.

7. The method of claim 6, wherein the receiving of the first request message comprises receiving the first request message via a second serving call session control function (S-CSCF) related to the second UE.

8. The method of claim 7, wherein the transmitting of the second request message comprises transmitting the second request message to the second UE via the second S-CSCF.

9. The method of claim 6, wherein the determining of whether the second UE supports the temporary connection to the IMS data channel comprises determining whether the second UE is capable of conditionally providing an IMS data channel service to a UE that is not subscribed to the IMS data channel, based on the second subscriber information.

10. The method of claim 9, further comprising:
transmitting, to the first IMS server, a first response message for allowing the temporary connection based on the second subscriber information.

11. A first Internet protocol (IP) multimedia subsystem (IMS) server in a wireless communication system, the first IMS server comprising:
a transceiver; and
a controller coupled with the transceiver and configured to:
receive a first request message for requesting a temporary connection to an IMS data channel (IMS DC) of a first user equipment (UE), which is originating UE,
transmit, to an home subscriber server (HSS) entity, a first subscriber information request message for requesting the first subscriber information of the first UE based on the first request message,
receive, from the HSS entity, a first subscriber information response message comprising the first subscriber information indicating that the first UE is not subscribed to the IMS data channel,
determine, based on the first subscriber information, whether the temporary connection to the IMS data channel of the first UE is allowed, and
in response to the determination to allow the temporary connection, transmit a second request message for requesting the temporary connection to the IMS data channel of the first UE to a second IMS server related to a second UE which is terminating UE.

12. The first IMS server of claim 11, wherein the controller is further configured to receive the first request message from the first UE via a first serving call session control function (S-CSCF) related to the first UE.

13. The first IMS server of claim 12, wherein the controller is further configured to transmit the second request message to a second S-CSCF related to the second UE via the first S-CSCF.

14. The first IMS server of claim 11, wherein the controller is further configured to determine whether to allow the temporary connection to the IMS data channel of the first UE based on second subscriber information of a second UE subscribed to the IMS data channel.

15. The first IMS server of claim 14, wherein the controller is further configured to:
receive, from the second IMS server, a first response message for allowing the temporary connection based on the second subscriber information,
allow the temporary connection to the IMS data channel of the first UE in response to receiving the first response message, and
transmit, to the first UE, a second response message representing that the temporary connection of the first UE is allowed.

16. A second Internet protocol (IP) multimedia subsystem (IMS) server in a wireless communication system, the second IMS server comprising:
a transceiver; and
a controller coupled with the transceiver and configured to:
receive, from a first IMS server related to a first user equipment (UE), which is an originating UE, a first request message for requesting a temporary connection to an IMS data channel (IMS DC) of the first UE,
transmit, to an home subscriber server (HSS) entity, a second subscriber information request message for requesting second subscriber information of a second UE, which is a terminating UE, based on the first request message,
receive, from the HSS entity, a second subscriber information response message comprising the second subscriber information indicating that the second UE is subscribed to the IMS data channel,
determine, based on the second subscriber information, whether the second UE supports the temporary connection to the IMS data channel, and
in response to determining that the second UE supports the temporary connection, transmit, to the second UE, a second request message for requesting the temporary connection to the IMS data channel of the first UE.

17. The second IMS server of claim 16, wherein the controller is further configured to receive the first request message via a second serving call session control function (S-CSCF) related to the second UE.

18. The second IMS server of claim 17, wherein the controller is further configured to transmit the second request message to the second UE via the second S-CSCF.

19. The second IMS server of claim 16, wherein the controller is further configured to determine whether the second UE supports the temporary connection by determining whether the second UE is capable of conditionally providing an IMS data channel service to a UE that is not subscribed to the IMS data channel, based on the second subscriber information.

20. The second IMS server of claim 19, wherein the controller is further configured to transmit, to the first IMS server, a first response message for allowing the temporary connection based on the second subscriber information.
